(19) United States
(12) Patent Application Publication
(10) Pub. No.: US 2021/0145225 A1
(43) Pub. Date: May 20, 2021

(54) BATHROOM STAND

(71) Applicant: Cynthia Davis, Fredericksburg, VA (US)

(72) Inventor: Cynthia Davis, Fredericksburg, VA (US)

(21) Appl. No.: 16/684,341

(22) Filed: Nov. 14, 2019

(51) Int. Cl. A47K 17/00; F16M 11/12; F16M 13/02

(52) U.S. Cl. CPC A47K 17/00; F16M 11/12; F16M 11/16; A47K 2201/02; F16M 13/02

(57) ABSTRACT

A bathroom stand for use in a bathroom is presented. The bathroom stand can be used to sanitarily and securely protecting a cellular phone, tablet, laptop, chrome book, book, etc. in a bathroom setting. The stand has a foot for stabilizing the stand. The stand has a post where a bottom end of the post coupled to the foot. The stand has a surface coupled to a top end of the post. The stand may be adjustable in height. The post may have one or more sections and the sections may be coupled together by joints. The joints may allow for the extending or retracting of the length of the post and/or may be moveable and lockable. The joint or couplings may further be swivels or hinges.

### FIELD OF THE INVENTION

This invention relates to accessories. More particularly, it relates to an accessory apparatus for bathrooms.

### BACKGROUND

A bathroom is a room in the home or hotel for personal hygiene activities, generally containing a toilet, a sink (basin) and either a bathtub, a shower, or both. In some countries, the toilet is usually included in the bathroom, whereas other cultures consider this insanitary or impractical, and give that fixture a room of its own. The toilet may even be outside of the home in the case of pit latrines. It may also be a question of available space in the house whether the toilet is included in the bathroom or not.

Historically, bathing was often a collective activity, which took place in public baths. In some countries the shared social aspect of cleansing the body is still important, as for example with sento in Japan and the “Turkish bath” (also known by other names) throughout the Islamic world.

In North American English the word “bathroom” may be used to mean any room containing a toilet, even a public toilet (although in the United States this is more commonly called a restroom and in Canada a washroom).

Some bathrooms contain a bathroom cabinet for personal hygiene products and medicines, and drawers or shelves (sometimes in column form) for storing towels and other items.

As technology has changed, people take different technology tools or devices to the bathroom with them. There is not device or apparatus which allows the tools or devices to be handsfree in a bathroom. Therefore there is a need for an apparatus or device to be mobile in a bathroom allowing the person to have access to the technology devices without burdening their hands.

### BRIEF DESCRIPTION OF THE DRAWINGS

FIG. 1 is an illustrated view of the exemplary bathroom stand.

FIG. 2A is an illustrated first height of the exemplary bathroom stand shown in FIG. 1.

FIG. 2B is an illustrated second height of the exemplary bathroom stand shown in FIG. 1.

FIG. 2C is an illustrated third height of the exemplary bathroom stand shown in FIG. 1.

FIG. 3 is an illustrated view of a use of the bathroom stand shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

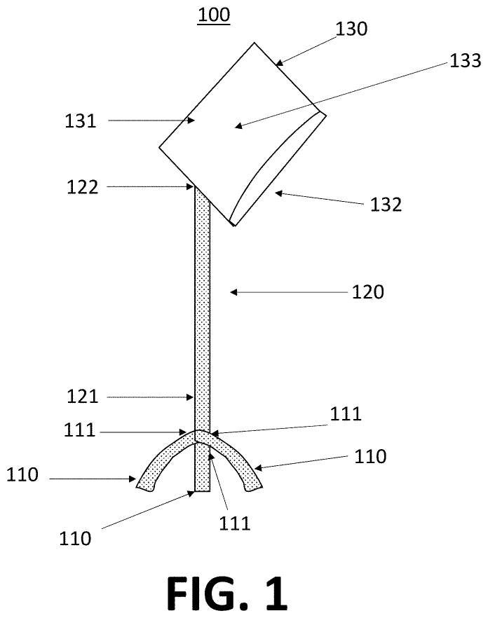

Referring to FIG. 1, an exemplary bathroom stand 100 for providing table space in a bathroom, which may be referred to as a “Handy Dandy Stand”, is presented. The exemplary bathroom stand 100 is useful for providing a place to hold a cellular phone, a tablet, a book, etc. Thus, while in the bathroom, a person can keep their personal items sanitary and clean.

The bathroom stand 100 has a foot 110, a post 120, and a surface 130. The bathroom stand 100 preferably can hold four to five (4-5) pounds, but may be built to hold more weight or less weight as desired.

The foot 110 may be a plurality of legs are preferably made of a metal such as steel, but may be made of a hard plastic, high-density polyethylene, aluminum, etc. The plurality of legs may be any size and may be of any number. The number of legs 110 is preferably three (3).

The top end 111 of each of the plurality of legs 110 are coupled to the post 120 at substantially near the bottom portion 121 of the post 120.

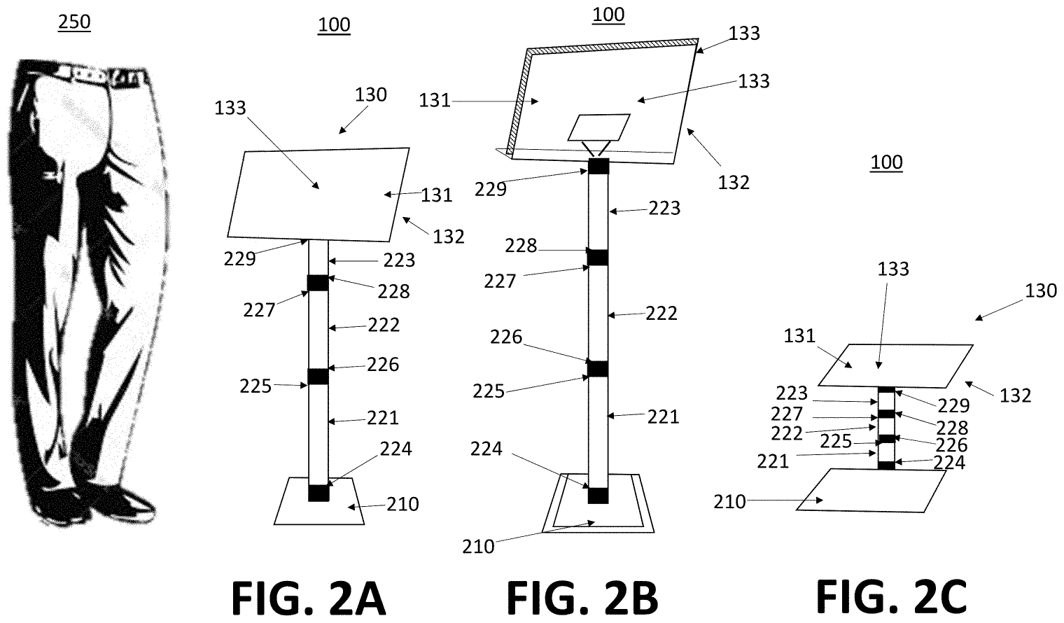

The post 120 is preferably adjustable, but may be static in height. The post 120 may be a single post or may be made of more than one section as will be shown in FIG. 2. The post may be of a metal such as steel, but may be made of a hard plastic, high-density polyethylene, aluminum, etc.

The surface 130 has a top 131 and a bottom 132. The bottom 132 has a middle portion 133. The surface 130 is preferably a flat surface, but the surface 130 my be slanted, an wedge shape, etc. The surface 130 is preferably made of high-density polyethylene but may be made of other materials such as steel, hard plastic, aluminum, PVC, etc. The surface 130 may have a clip (not shown), Velcro, raised edges, etc.

A top end 122 of the post 120 is coupled at substantially the middle portion 133 of the bottom 132 of the surface 130. The coupling may be a hard, non-movable coupling, but may be a swivel coupling, hinged coupling, etc.

Moving now to FIG. 2A, FIG. 2B, FIG. 2C, the bathroom stand 100 of FIG. 1 is shown with different heights as is shown in comparison to the legs of a human being 250. The different heights is useful to position the bathroom stand 100 to a height that is comfortable for the user. Further, by adjusting the height, the stand is easily storable and portable.

The bathroom stand 100 has a flat base 210 for the foot 130 of the bathroom stand 100 shown in FIG. 1. The flat base 210 is preferably made of a metal such as steel, but may be made of a hard plastic, high-density polyethylene, aluminum, etc.

The bathroom stand 100 is shown as adjustable in height in FIG. 2. To accomplish the adjustability of the bathroom stand 100 the post 120 has one or more sections 221, 222, 223.

A first end 224 a first of the one or more sections 221 is coupled to the flat base 210 or legs 110. A second end 225 of the first of the one or more sections 221 is coupled to a first end 226 of a second of the one or more sections 222. The coupling is performed by a coupling mechanism. The coupling mechanism may be a hole and peg coupling, a clamp coupling, a slide coupling, etc.

A second end 227 of the second of the one or more sections 222 is coupled to a first end 228 of a third of the one or more sections 223. The coupling is performed by a coupling mechanism. The coupling mechanism may be a hole and peg coupling, a clamp coupling, a slide coupling, etc.

A second end 229 of the third of the one or more sections 223 is coupled at substantially the middle portion 133 of the bottom 132 of the surface 130. The coupling may be a hard, non-movable coupling, but may be a swivel coupling, hinged coupling, etc.

FIG. 2A is substantially at a height equal to or substantially near the height of the top of the legs of the human being 250. FIG. 2B shows the bathroom stand 100 being adjusted to be at a taller height substantially higher than the waist of the human being 250. FIG. 2C shows the bathroom stand 100 being at a lower height at substantially near the knee height level of the human being 250

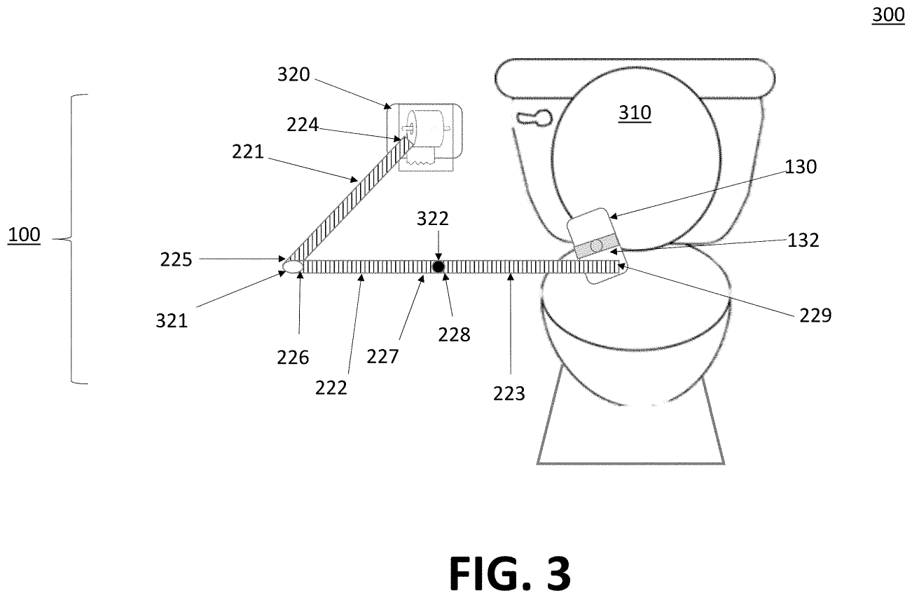

Now referring to FIG. 3, the bathroom stand 100 of FIG. 1 is shown in use in a bathroom.

The bathroom 300 has a commode 310 and a toilet paper holder 320 The commode 300 is useful for taking the waste of a human and disposing of it to a sewer system. The toilet paper holder 320 is useful as a place to provide toilet paper to a user. The toilet paper holder 320 is securely coupled to a wall of the bathroom 300.

The legs 110 and/or flat base 210 is replaced by the toilet paper holder 320, thus the first end 224 of the first of the one or more sections 221 is coupled to the toilet paper holder 320, therefore the toilet paper holder 320 is performing as the foot 110 of the bathroom stand 100.

The posts 120 has the first section 221, the second section 222 and the third section 223. The second end 225 of the first section 221 is moveably coupled by a moveable coupling 321 to the first end 226 of the second section 222. The moveably coupling 321 is a joint which can be moved into different positions to direct the surface 130 into a predetermined location.

The second end 227 of the second section 222 is coupled by an adjustable coupling 322 to the first end 228 of the third section 223. The adjustable coupling 322 is a joint which can allow the third section 223 to be extended or contracted to a predetermined length and adjusted in real time.

The second end 229 of the third section 223 is coupled by a swivel coupling 323 to the middle portion 133 of the bottom 132 of the surface 130.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A bathroom stand for use in a bathroom, the stand comprising:
A foot, the foot for stabilizing the stand;
A post, a bottom end of the post coupled to the foot;
A surface, the surface being coupled to a top end of the post; and
Wherein the stand being adjustable in height.

2. The stand of claim 1, the post further comprising:
A plurality of sections, wherein each of the plurality of sections being coupled by a coupling.

3. The stand of claim 2, wherein the coupling extending at least one of the plurality of sections.

4. The stand of claim 3, wherein the coupling being a joint.

5. The stand of claim 4, wherein the joint being a moveable joint, wherein the movable joint being lock in a determined position.

6. The stand of claim 2, wherein the coupling decreasing a length of at least one of the plurality of sections.

7. The stand of claim 6, wherein the coupling being a joint.

8. The stand of claim 7, wherein the joint being an adjustable joint.

9. The stand of claim 1, wherein the coupling of the surface to the top end of the post being a swivel.

10. The stand of claim 1, wherein post being made of high-density polyethylene.

11. The stand of claim 1, wherein foot being made of high-density polyethylene.

12. The stand of claim 1, wherein surface being made of high-density polyethylene.

13. The stand of claim 1, wherein the surface being flat.

14. The stand of claim 1, wherein the surface having a raised edge.

15. The stand of claim 1, wherein the surface having a clip.
